(19) United States
(12) Patent Application Publication
(10) Pub. No.: US 2024/0060369 A1
(43) Pub. Date: Feb. 22, 2024

(54) INTEGRATED WELLSITE PROCESSING SYSTEM AND WELLSITE MONITORING SYSTEM AND METHOD OF USING SAME

(71) Applicant: GR Energy Services Management, LP, Sugar Land, TX (US)

(72) Inventors: Cameron Michael Bryant, Sugar Land, TX (US); James William ANTHONY, Missouri City, TX (US); David Chesney, Houston, TX (US); Roma Montifar, Katy, TX (US); Tyler Chaney, Rosharon, TX (US); Andres C Villareal, Duncanville, TX (US); David M Headley, Manvel, TX (US); Julio C. Guerrero, Cambridge, MA (US); Jeffree Sea Dickinson, Sugar Land, TX (US)

(73) Assignee: GR Energy Services Management, LP, Sugar Land, TX (US)

(21) Appl. No.: 18/271,444

(22) PCT Filed: Jan. 9, 2022
(86) PCT No.: PCT/US22/11740

§ 371 Date: Jul. 7, 2023

Related U.S. Application Data
(60) Provisional application No. 63/135,610, filed on Jan. 9, 2021.

(51) Int. Cl. E21B 19/16

(52) U.S. Cl. CPC E21B 19/165; E21B 19/161

(57) ABSTRACT

An integrated tool processing system and a wellsite monitoring system for a wellsite. The integrated tool processing system includes a tool assembler, a tool lift, and a tool transporter. The tool assembler includes a tool conveyor and a gun builder. The tool lift is connected by a tool stager to the tool assembler. The tool lift includes a lift base to receive the downhole tool and a lift arm to lift the downhole tool. The tool transporter includes a vehicle and a boom for connection to the downhole tool. The vehicle and the boom carry the downhole tool into position for delivery at the wellsite. The wellsite monitoring system includes wellsite sensors to collect wellsite data, wellsite monitors to receive and analyze the wellsite data, and a central station to collect and further analyze the wellsite data and to operate the tool processing system based on the combined wellsite data.

### CROSS-REFERENCE TO RELATED APPLICATIONS

This application claims the benefit of U.S. Patent Application No. 63/135,910 entitled “Wellbore Gun Builder with Gun Chucks and Method of Using Same” filed on Jan. 9, 2021, the entire contents of which is hereby incorporated by reference herein to the extent not inconsistent with the present disclosure. Applicant is the owner of PCT Patent Application No. PCT/US22/11739 entitled “Wellsite Monitoring System with Wellsite Tracker and Method of Using Same” and PCT Patent Application No. PCT/US22/11740 entitled “Wellbore Gun Builder with Gun Chucks and Method of Using Same” filed on the same day herewith, the entire contents of which are hereby incorporated by reference herein to the extent not inconsistent with the present disclosure.

### BACKGROUND

The present disclosure relates generally to oilfield technology. More specifically, the present disclosure relates to techniques for assembling, delivering, and monitoring oilfield equipment.

Wellsite operations are performed to locate and access subsurface targets, such as valuable hydrocarbons. Drilling equipment is positioned at the surface and a downhole drilling tool is advanced into the subsurface formation to form a wellbore. Once drilled, casing may be inserted into the wellbore and cemented into place to complete a well. Once the well is completed, production equipment may be deployed into the wellbore to facilitate production of fluid to the surface for capture.

Various equipment may be used to perform the wellsite operations. Examples of equipment used at wellsites are provided in Patent/Application Nos. US2020/0072029, US2006/0278394, U.S. Ser. No. 10/329,858, WO2014028317, U.S. Pat. Nos. 6,216,789, 6,995,682, US2013/0138254, and U.S. Pat. No. 9,127,545, the entire contents of which is hereby incorporated by reference herein to the extent not inconsistent with the present disclosure. The equipment may include, for example, downhole drilling and other tools deployed into the earth. Examples of downhole tools are provided in US Patent/Application Nos. 2020/0024935; 10507433; 10,036,236; 2020/0072029; US2020/0048996; 2016/0115753; 2020/0277837; 20190376775; 20190330947; 20190242222; 20190234189; 10309199; 20190127290; 20190086189; 20180299239; 20180224260; 9915513; 20180038208; 9822618; 9605937; 20170074078; 9581422; 20170030693; 20160356432; 20160061572; 8960093; 20140033939; 8267012; 6520089; 20160115753; 20190178045; and 10365079, the entire contents of which is hereby incorporated by reference herein to the extent not inconsistent with the present disclosure. The downhole tools may be made of multiple components assembled together. Examples of assembly techniques are provided in U.S. Pat. Nos. 7,896,083; 11,066,75: and 9,581,422, the entire contents of which is hereby incorporated by reference herein to the extent not inconsistent with the present disclosure.

Various devices may be used with the equipment at the wellsite. For example, devices are used to move the equipment to a desired location. Examples of such devices are provided in Patent/Application Nos. U.S. Pat. Nos. 6,543,538, 9,617,829, WO2009/023042, WO2014028317, and U.S. Pat. No. 6,216,789 the entire contents of which is hereby incorporated by reference herein to the extent not inconsistent with the present disclosure. Devices are also used to collect measurements at the wellsite. Examples of such devices are provided in Patent/Application Nos. US2019/0211664 and US20080264649, the entire contents of which is hereby incorporated by reference herein to the extent not inconsistent with the present disclosure.

Despite the advancements in downhole technology, there remains a need for efficient techniques for reliably assembling, delivering, and monitoring equipment for use at the wellsite. The present disclosure is directed at providing such needs.

### SUMMARY

In at least one aspect, the disclosure relates to a tool processing system. The tool processing system comprises a tool assembler; a tool stager; a tool lift; and a tool transporter. The tool assembler comprises a gun builder.

In another aspect, the disclosure relates to a method of processing tools. The method comprises assembling a downhole tool; staging the downhole tool; lifting the downhole tool; and transporting the downhole tool to a wellsite.

In yet another aspect, the disclosure relates to a wellsite system. The wellsite system comprises the tool processing system and a wellsite monitoring system coupled to the tool processing system to process tool parameters received therefrom. The tool monitoring system comprises sensors and monitors. The sensors comprise a well tracker.

Finally, in another aspect, the disclosure relates to a method of monitoring a wellsite. The method comprises collecting processing parameters from processing sensors positioned about the tool processing system; collecting wellsite parameters from wellsite sensors positioned about the wellsite; generating a wellsite analysis of wellsite operations based on the processing parameters and the wellsite parameters; and adjusting the tool operations and/or the wellsite operations based on the wellsite analysis.

The processing sensors comprise a wellsite tracker, and the collecting processing parameters comprises collecting location parameters from the wellsite tracker. The method further comprises generating a processing analysis of processing operations based on the processing parameters, the location parameters, and the wellsite parameters; and adjusting the processing parameters based on the processing analysis.

In yet another aspect, the disclosure relates to a method of monitoring wellsite operations. The method involves positioning a tool processing system at a wellsite, the tool processing system comprising a tool assembler, a tool stager, a tool lift, and a tool transporter; assembling a downhole tool with the tool assembler; staging the downhole tool with the tool stager; lifting the downhole tool with the tool lift; and transporting the downhole tool to a well with the tool transporter. The method may also involve storing tool components. The method further involves collecting tool parameters (e.g., location) from processing sensors positioned about a tool processing system, collecting wellsite parameters from wellsite sensors positioned about the wellsite at a central station, generating a processing analysis of processing operations based on the processing parameters and the wellsite parameters, and adjusting the processing operations and/or the wellsite operations based on the wellsite analysis.

The disclosure also relates to a tool processing system, a wellsite system, a wellsite monitoring system, methods of processing tools, and methods of monitoring wellsite operations as described herein.

In at least one aspect, the disclosure relates to an integrated tool processing system for processing a downhole tool at a wellsite. The integrated tool processing system comprises a tool assembler, a tool lift, and a tool transporter. The tool assembler comprises assembly equipment positioned at the wellsite. The assembly equipment comprises a tool conveyor and a gun builder positioned along the tool conveyor. The gun builder comprises gun chucks to threadedly connect portions of the downhole tool together. The tool lift is operatively connected by a tool stager to the tool assembler. The tool stager comprises a staging conveyor connected between the tool conveyor and the tool lift to transfer the downhole tool therebetween. The tool lift comprises a lift base to receive the downhole tool and a lift arm. The lift arm is movably positionable at an angle to the lift base whereby the downhole tool is lifted about the lift base. The tool transporter comprises a vehicle positionable about the wellsite and a boom extending above the vehicle. The boom is positionable about the lift arm and connectable to the downhole tool. The vehicle and the boom carry the downhole tool into position for delivery at the wellsite.

In another aspect, the disclosure relates to a method of processing downhole tools for use at a wellsite. The method comprises assembling a downhole tool by: passing portions of the downhole tool along an assembly conveyor and into a gun builder; and threadedly connecting the portions of the downhole tool using the gun builder; passing the downhole tool from the gun builder to a tool lift by passing the downhole tool from the assembly conveyor to the tool lift via a tool stager; lifting the downhole tool at an angle using the tool lift; and transporting the downhole tool from the tool lift to a wellsite.

In yet another aspect, the disclosure relates to a wellsite monitoring system for monitoring wellsite equipment at a wellsite. The wellsite monitoring system comprises wellsite sensors positioned about the tool processing system to collect wellsite data; wellsite monitors positioned about the wellsite, and a central station. The wellsite monitor coupled to the wellsite sensors to receive wellsite data therefrom. The wellsite monitors comprise monitor processors to generate monitor outputs based on the wellsite data. The central station is positioned at the wellsite. The central station is coupled to the wellsite monitors to receive the wellsite data and the generated outputs therefrom. The central station comprises a central processor to generate central outputs based on the monitor outputs and the wellsite data.

Finally, in another aspect, the disclosure relates to a method of monitoring wellsite operations at a wellsite. The method comprises collecting tool parameters from tool sensors positioned about the tool processing system; collecting wellsite parameters from wellsite sensors positioned about wellsite equipment at the wellsite; generating a tool analysis of processing operations based on the tool parameters, the tool analysis comprising a location of the downhole tool over time; generating a wellsite analysis based on the tool parameters and the wellsite parameters; and performing processing operations based on the wellsite analysis.

In at least one aspect, the present disclosure relates to a wellbore gun builder, comprising: a feed assembly and a chuck assembly. The feed assembly comprises a conveyor assembly and a linear actuator. The chuck assembly comprises a rotating gun chuck, an axial gun chuck, and chuck jaws.

In another aspect, the present disclosure relates to a method of building a wellbore gun, comprising: feeding gun components of the wellbore gun along a feed assembly and into a build assembly; and selectively connecting the gun components of the wellbore gun with chucks of the build assembly. The method may involve feeding a first gun carrier, a gun sub, and a second gun into a chuck assembly with the gun sub positioned between the first gun carrier and the second gun carrier, gripping the first gun carrier with an axial gun chuck of the chuck assembly, gripping the second gun carrier with a rotating gun chuck of the chuck assembly, and securing the gun sub to the first gun carrier and the second gun carrier by: applying a torque to rotate rotating gun chuck; and allowing the axial gun chuck to move axially about the rotating gun chuck.

In at least one aspect, the present disclosure relates to a chuck assembly for assembling a wellbore gun. The chuck assembly comprises a chuck housing, a rotating gun chuck, and an axial gun chuck. The rotating gun chuck is positioned in the chuck housing and rotationally movable thereabout. The rotating gun chuck has a first hole therethrough. The rotating gun comprises chuck jaws radially movable about the first hole in the rotating chuck to selectively grip a portion of the wellbore gun. The axial gun chuck is positioned in the chuck housing and axially movable thereabout, the axial gun chuck having a second hole therethrough. The axial gun chuck comprises chuck jaws radially movable about the second hole in the axial gun chuck to selectively grip another portion of the wellbore gun. The second hole of the axial gun chuck aligned with the first hole of the rotating gun chuck to define a passage for receiving the wellbore gun therethrough. The rotating gun chuck is rotationally positioned about the axial gun chuck to selectively rotate the portion of the wellbore gun as the axial gun chuck moves axially about the chuck housing whereby the portion of the wellbore gun is threadedly connected to the another portion of the wellbore gun.

In another aspect, the disclosure relates to a wellbore gun builder for assembling a wellbore gun. The wellbore gun builder comprises the chuck assembly as in claim 1; and a feed assembly comprising a conveyor positioned about the chuck assembly to selectively feed the wellbore gun through the passage.

In yet another aspect, the disclosure relates to a method of building a wellbore gun. The method comprises feeding gun components of the wellbore gun into a build assembly by: feeding a first gun, a gun sub, and a second gun into a chuck assembly with the gun sub positioned between the first gun and the second gun; gripping the first gun with an axial gun chuck of the chuck assembly; and gripping the second gun with a rotating gun chuck of the chuck assembly. The method further comprises: selectively connecting the gun components of the wellbore gun with the build assembly by: applying a torque to rotate the rotating gun chuck; and allowing the axial gun chuck to move axially about the rotating gun chuck.

In at least one aspect, the present disclosure relates to a wellsite tracker. The wellsite tracker comprises a tracker housing; a communication unit positioned in the tracker housing; and a location unit. The location unit is positioned in the tracker housing to collect location data. The location unit comprises a three-axis location sensor. The location data comprises spatial location and time.

In another aspect, the disclosure relates to a wellsite monitoring system. This system comprises the wellsite tracker and a wellsite monitor. The wellsite monitor is communicatively coupled to the communication unit to receive the location data therefrom. The wellsite monitor comprises a central processor to generate outputs based on the location data.

The disclosure also relates to a wellsite tracker, a wellsite monitoring system, and methods of monitoring wellsite operations as described herein.

The method of monitoring wellsite operations comprises positioning a wellsite tracker about a transporter; positioning the transporter about the wellsite; using the wellsite tracker, detecting location data; and generating outputs based on the location data. The outputs comprise an inferred location of well equipment.

In another aspect, the disclosure relates to a wellsite tracker for tracking wellsite equipment at a wellsite. The wellsite tracker comprises a tracker housing, a location antenna, a location unit, and a communication unit. The tracker housing is positionable on the wellsite equipment. The tracker housing has an antenna chamber and a component chamber. The component chamber is isolated from the antenna chamber by a barrier. The location antenna is positioned in the antenna chamber. The location antenna is coupled to a plurality of coordinate satellites to receive location data therefrom. The location data comprises three-axis coordinate data. The location unit is positioned in the component chamber and coupled to the location antenna to receive the location data therefrom. The location unit comprises a clock and a location processor to receive the location data over time and to infer tracking data based on the location data and the time. The tracking data comprises spatial location and the time of the wellsite equipment based on the location data. The tracker communicator comprises a communication unit and a communication antenna. The communication unit is positioned in the component chamber and coupled to the location unit to receive the tracking data therefrom. The communication antenna is positioned in the antenna chamber and coupled to the communication unit to receive the tracking data therefrom. The communication antenna extends through the tracker housing to transmit the tracking data about the wellsite.

In another aspect, the disclosure relates to a wellsite monitoring system for monitoring wellsite equipment at a wellsite. The wellsite monitoring system comprises the wellsite tracker; and a wellsite monitor. The wellsite monitor is coupled to the communication antenna of the wellsite tracker to receive the tracking data therefrom. The wellsite monitor comprises a monitor processor to generate outputs based on the location data.

Finally, in another aspect, the disclosure relates to a method of monitoring wellsite operations at a wellsite. The method comprises positioning a wellsite tracker about wellsite equipment at the wellsite, the wellsite equipment comprising a transporter; using the wellsite tracker, receiving location data from a plurality of satellites as the well site equipment moves about the wellsite; inferring tracking data for the wellsite equipment based on the location data over time, the tracking data comprising spatial location and the time of the wellsite equipment; and confirming wellsite operations by comparing the tracking data for the wellsite equipment with predetermined specifications.

This Summary is not intended to be limiting and should be read in light of the entire disclosure including text, claims and figures herein.

### BRIEF DESCRIPTION OF THE DRAWINGS

So that the above recited features and advantages of the present disclosure can be understood in detail, a more particular description of the invention, briefly summarized above, may be had by reference to the embodiments thereof that are illustrated in the appended drawings. The appended drawings illustrate example embodiments and are, therefore, not to be considered limiting of its scope. The figures are not necessarily to scale and certain features, and certain views of the figures may be shown exaggerated in scale or in schematic in the interest of clarity and conciseness.

FIGS. 1A-1B are schematic diagrams depicting views of a wellsite with a tool processing system.

FIG. 2 is a schematic diagram depicting another view of the wellsite and the tool processing system.

FIGS. 3A and 3B are schematic diagrams depicting the tool processing system.

FIGS. 4A-4D are schematic diagrams depicting various views of a tool assembler.

FIGS. 5A and 5B are schematic diagrams depicting a tool lift.

FIG. 6 is a flow chart depicting a method of processing a downhole tool.

FIG. 7A-7B are schematic diagrams depicting the tool processing system and a wellsite monitoring system positioned about the wellsite.

FIG. 8 is a schematic diagram depicting the wellsite monitoring system performing multiple well operations.

FIG. 9 is a flow chart depicting a method of monitoring wellsite operations.

### DETAILED DESCRIPTION

The description that follows includes exemplary apparatus, methods, techniques, and/or instruction sequences that embody techniques of the present subject matter. However, it is understood that the described embodiments may be practiced without these specific details.

### Integrated Tool Processing System

This disclosure relates to a tool processing system for assembling and delivering a downhole (or other wellsite) tool, such as a perforating gun. The tool processing system includes multiple processing devices (stages): a tool assembler for assembling the downhole tool, a tool stager for staging the downhole tool, a tool lift for positioning the downhole tool, and a tool transporter for transporting the downhole tool. Each of these processing devices may be configured with their own individual structure for performing their separate individual functions. For example, the tool assembler may use a gun builder to automatically assemble (e.g., thread) portions of the downhole tool together, the stager may have the ability to store and select the assembled downhole tools, the tool lift may have the ability to facilitate transport of the selected downhole tools by positioning the downhole tool, and the tool transporter may have the ability to move the lifted downhole tool to a selected well. Part or all of these individual functions may be performed individually or in combination for selected optimization of the functions.

The processing devices may be integrated and/or connected for sequential use to provides a unitary system for processing the downhole tool for use at a wellsite for use. The tool processing system may integrate the multiple processing devices and their associated tool operations into a single and continuous assembly for cycling of multiple downhole tools. The individual processing devices may also be integrated (e.g., connected together), for example, by transfer devices, such as conveyors, to provide a unified structure linking the individual functions and facilitating flow between the individual stages. This flow may be used, for example, to provide speed, efficiency, and safety while interconnecting the individual functions for consistency and alignment. Individual, overlapping, and/or combined portions of the tool processing system may be pre-set to pre-defined specifications to provide optimization across multiple of the processing devices. The tool processing system may also provide a repeatable structure with full or semi-automation, a fixed location, and a pre-set footprint positionable on or offsite.

The tool processing system and methods described herein are also intended to provide one or more of the following, among others: quick assembly, precise assembly, efficient assembly, simplified operation, repeatable operation, automated or semi-automated processing, multiple linked assembly operations for processing downhole tools, integrated operation for efficient processing, quick cycling of downhole tools, on or offsite assembly and/or pre-assembly, enhanced equipment reliability, reduction in cost, flexibility of use, time savings, efficient operation, reduced maintenance costs, transportability, etc.

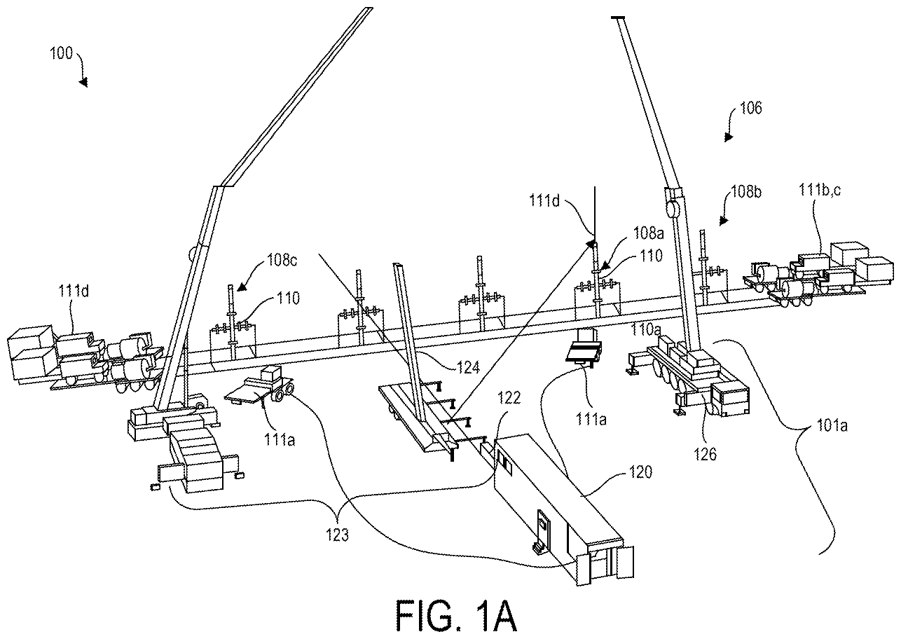

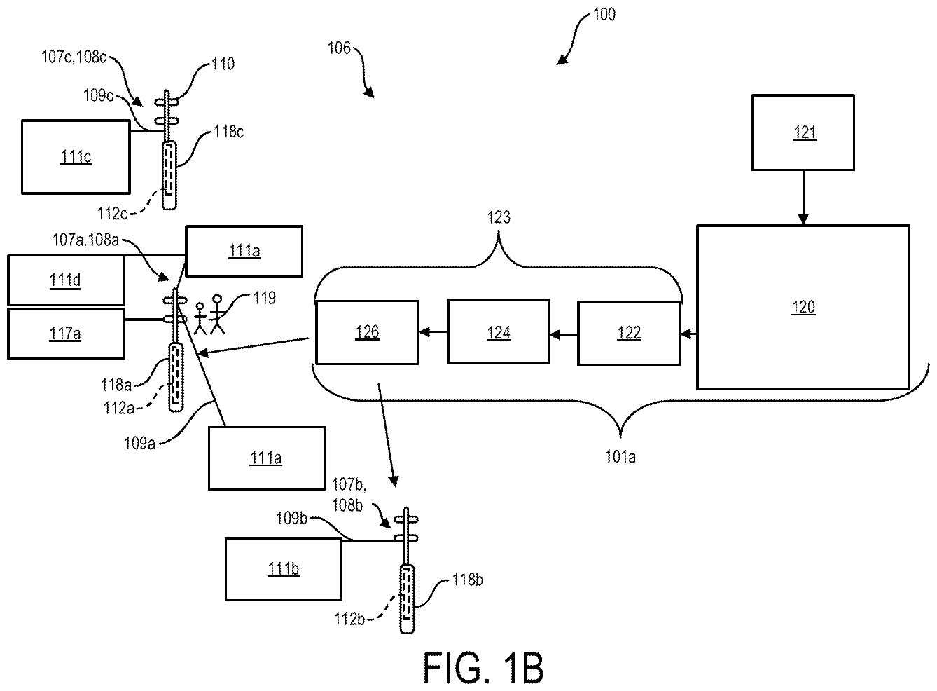

FIGS. 1A-1B are schematic diagrams depicting a wellsite 100 with a tool processing system 101a. These figures show an example wellsite 100 that may be used for processing (e.g., assembling, staging, storing, lifting, transferring, etc.) part or all of wellsite equipment, such as a downhole tool, for use at the wellsite 100. In this example, the wellsite 100 is a well pad with wells 108a-c thereon. The wellsite 100 may be provided with wellsite equipment 106 for processing and/or use at the wellsite 100.

The well equipment 107a-c may be used independently, or in combination, and with one or more wells 108a-c. The well equipment 107a-c at each of the wells 108a-c includes surface equipment 110 and downhole tool 112a-c. In the example shown, the surface equipment 110 at each of the wells 108a-c includes a production well head extending a distance above the surface. The well equipment 107a-c may also include other equipment, such as conveyance carriers (e.g., winch or tubing spools) 111a for supporting a conveyance 109a-c, injection equipment 111b for injecting fluid into the wellbore as shown at well 108b, fracking equipment 111c for fracturing subsurface formations as shown at well 108c, and a wireline truck 111d for performing downhole operations (e.g., perforating).

The surface equipment may also include a surface unit 117a for operating equipment at one or more of the wells 108a-c. The surface unit 117a may be standard control equipment for operating the wells 108a-c, such as hydraulic, electronic, and/or other controllers (e.g., central processing units (CPUs)). In the examples shown, the surface unit 117a is coupled to well 108a and the wireline truck 111d for performing a wireline operation. A crew 119 of one or more workers may also be provided for performing operations at the wells 108a-c.

The downhole tool 112a-c may include various downhole tools positionable in the wellbores 118a-c for performing downhole operations, such as a perforating tool 112a as shown at well 108a, an injection tool 112b as shown in well 108b, and a fracking tool 112c as shown at well 108c. The perforating tool 112a may be, for example, a perforating gun as described in US Patent Application No. 2020/0072029, previously incorporated by reference herein.

The wellsite equipment 106 also includes the tool processing system 101a. The tool processing system 101a includes a tool assembler 120 and a tool transfer 123. The tool processing system 101a may also include other components, such as component storage 121 for housing tool components used to form the downhole tools 112a-c. The tool assembler 120 may include various assembly tools for connecting tool components together to form the downhole tool 112a-c as is described further herein.

Once assembled, the downhole tool 112a-c is moved from the tool assembler 120 to the tool transfer 123. The downhole tool 112a-c may then be moved by the tool transfer 123 from the tool assembler 120 to a select well 108a-c. In the example shown, the tool transfer 123 includes tool stager 122 for storing the downhole tool 112a-c, a tool lift 124 for positioning the downhole tool 112a-c, and a tool transporter 126 for transporting the downhole tool 112a-c to the well 108a-c as is described further herein.

FIGS. 1A and 1B also show example wellsite operations at wells 108a-c that may be used with the wellsite equipment 106 at the wellsite 100. The first well 108a shows a perforating operation with the downhole tool 112a deployed into the wellbore 118a by the conveyance (wireline) 109a for forming perforations to facilitate production of subsurface fluids. The downhole tool 112a (and the conveyance 109a) may be raised and lowered about the wellbore 118a-c by the winch 111a. The second well 108b shows an injection operation with the downhole tool 112b positioned in the wellbore 118b for injecting fluid. The downhole injection tool 112b is coupled to the injection equipment 111b by the conveyance (tubing) 109b. The injection equipment 110b may be, for example, fluid tanks with pumps for pumping fluids for injection fluid into the surrounding formation. The downhole injection tool 112c is coupled to the fracking equipment 111b by the conveyance (flowlines) 109c. The third well 108c shows a fracking operation with the downhole tool 112c positioned in the wellbore 118c for fracking the formation. The fracking equipment 111b may be, for example, one or more blender, mixing, or other trucks with pumps for pumping fracking fluids into the surrounding formation.

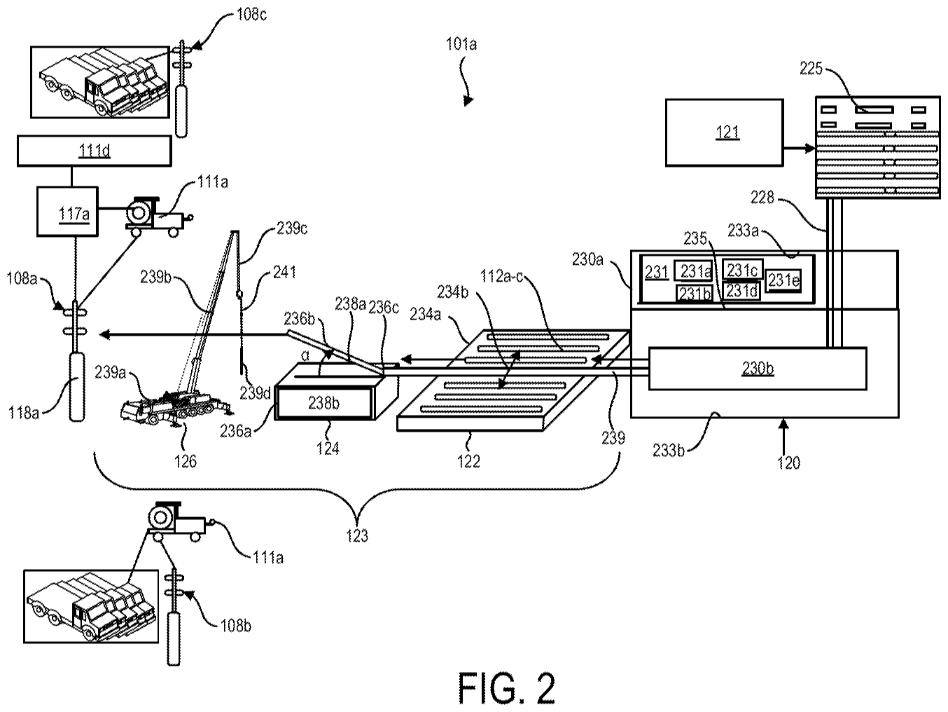

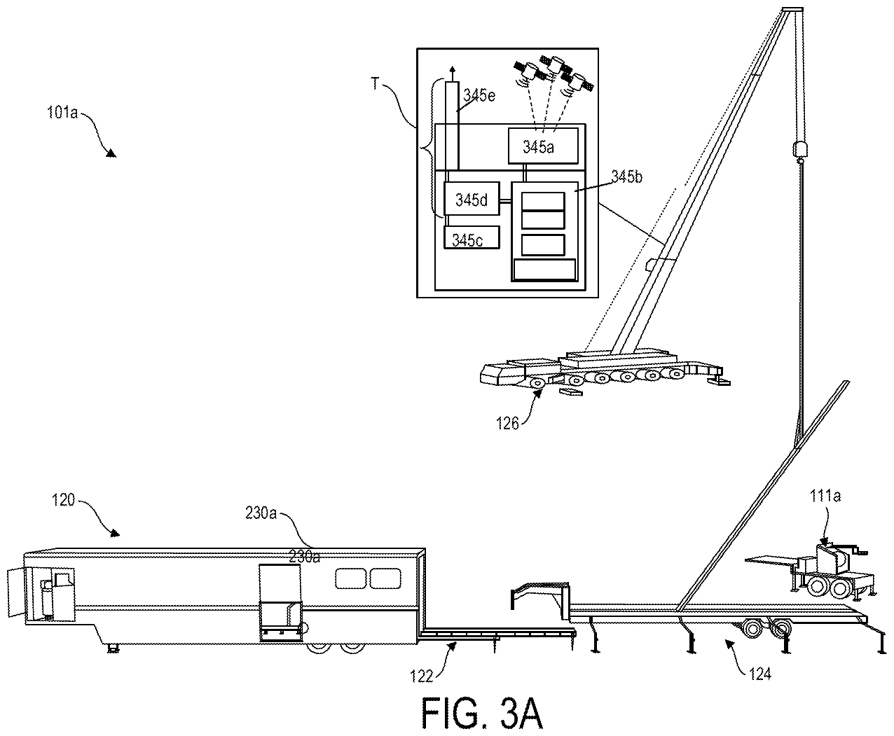

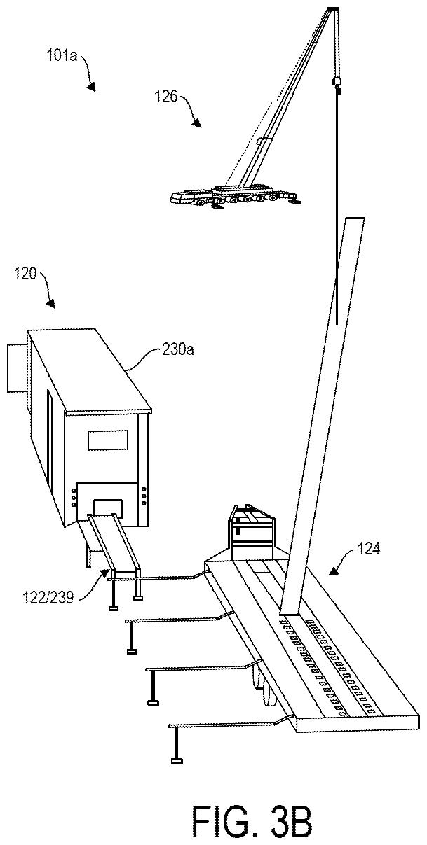

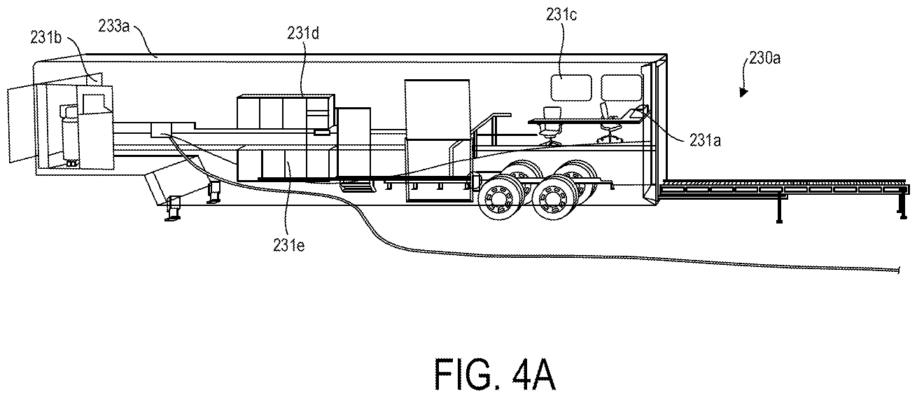

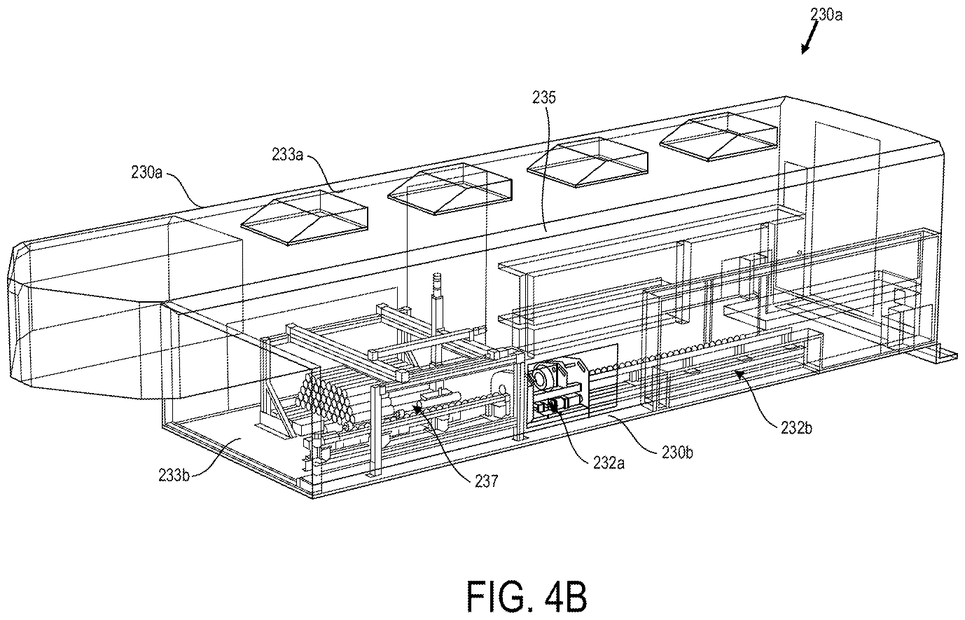

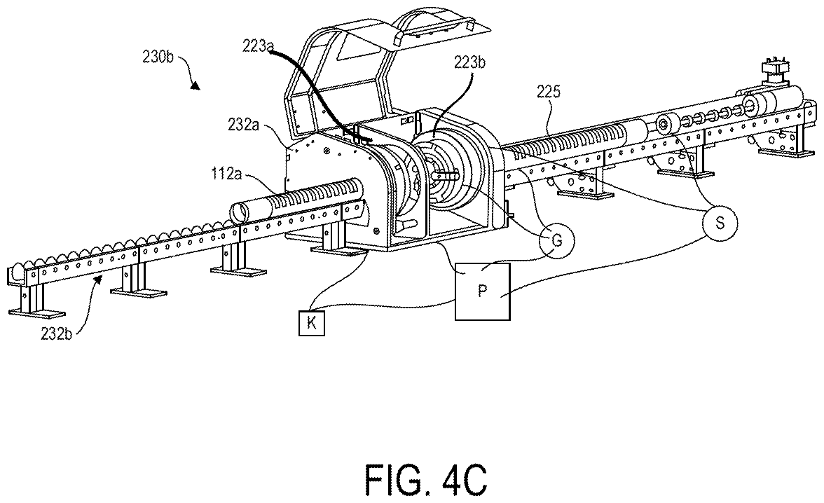

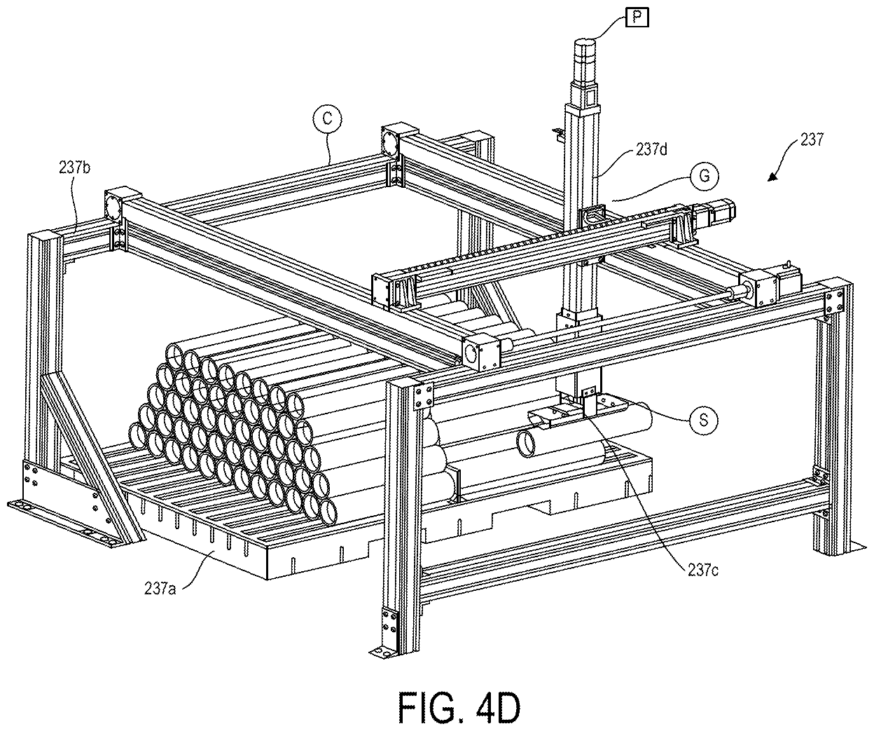

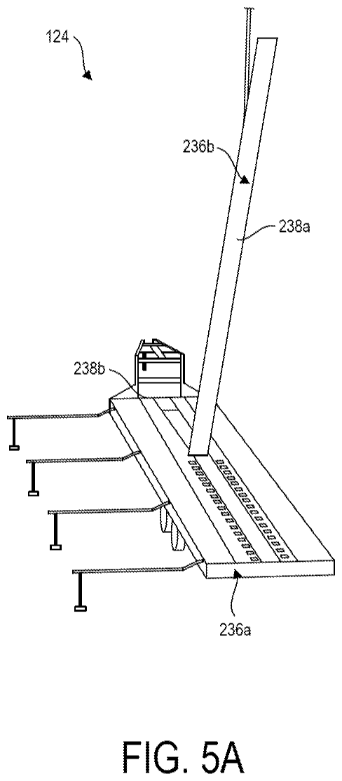

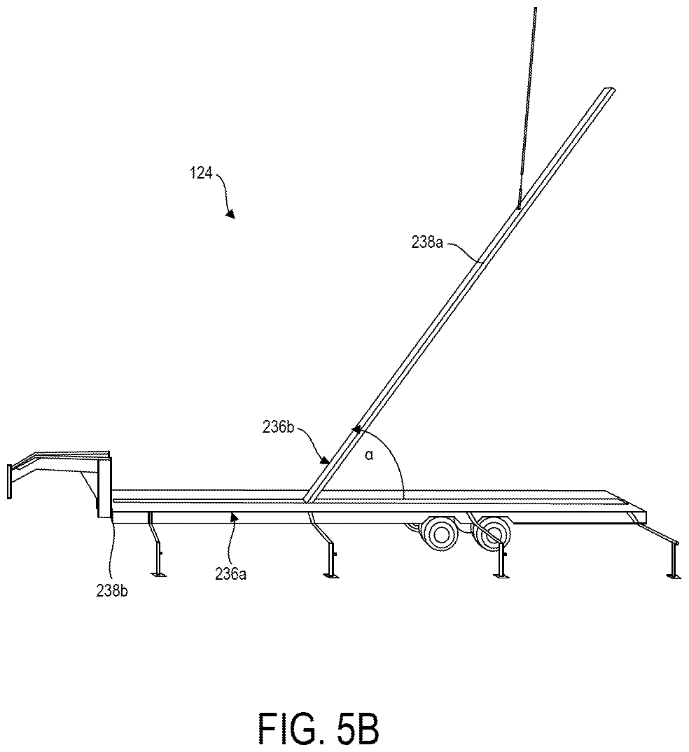

FIG. 2 is a schematic diagram depicting the tool processing system 101a in an integrated configuration. FIGS. 3A-5B show the components of the tool processing system 101a in greater detail. FIGS. 3A-3B are schematic diagrams depicting the tool processing system. FIGS. 4A-4D are schematic diagrams depicting a tool assembler. FIGS. 5A and 5B are schematic diagrams depicting a tool lift.

As shown in FIGS. 2, 3A, and 3B, the tool processing system 101a includes multiple processing components, connected together to form a unified assembly. The processing components include the tool assembler 120, and the tool transfer 123 integrated together into a combined system. This integrated configuration of the tool processing system 101a may be used to process any of the downhole tools 112a-c (or other wellsite equipment 106) from start to finish. The integrated tool processing system 101a may be positioned onsite for performing multiple stages of a processing operation for providing the downhole tools 112a-c for use at any of the wells 108a-c.

As shown in FIG. 2, the processing components may also include the component storage 121. The component storage 121 may be any container, such as a shelf, shed, box, etc. for storing one or more of the tool components 225 and/or other wellsite equipment 106 (FIGS. 1A and 1B). The tool components 225 may include, for example, subs, housing, electronics, and other portions of one or more of the downhole tools 112a-c. The tool components 225 may be, for example, portions of the downhole perforating tool 112a for performing perforations in the wellbore 118a at well 108a (FIGS. 1A and 1B).

The component storage 121 may be coupled to the tool assembler 120 by a tool feeder 228 for delivering the tool components 225 to the tool assembler 120. The tool feeder 228 may be any device capable of moving the components to the tool assembler 120 for assembly. The tool feeder 228 may be, for example, a crane, conveyor, loader, or other feeding device for lifting, positioning, lowering, and/or transferring the tool components 225 to the tool assembler 120. The tool feeder 228 may be operatively connected to and/or integrated with the tool assembler 120 to work therewith. For example, the tool feeder 228 may be a conveyor connected from the component storage 121 to portions of the tool assembler 120, such as another conveyor of the tool assembler 120, to feed the tool components 225 directly into the tool assembler 120. The tool feeder 228 may also have capabilities for scanning and monitoring the tool components and/or for performing storage and/or feed operations as is described further herein.

As shown in FIGS. 2, 3A—3B, and 4A-4D, the tool assembler 120 may include an assembly facility 230a and assembly equipment 230b. The assembly facility 230a may be any structure capable of housing the assembly equipment 230b during assembly operations. The assembly facility 230a may be a mobile structure, such as a trailer capable of housing and transporting the assembly equipment 230b to various locations before, during, and/or after assembly. Examples of an assembly facility and assembly equipment that may be used are described in U.S. Patent Application No. 63/135,910 and PCT Patent Application No. PCT/US22/11739, previously incorporated by reference herein.

The assembly facility 230a may also have separate rooms, such as an assembly room 233a for housing the assembly equipment 230b and an operations room 233b for housing operation components. The operations room 233b may be isolated from the operations room by a barrier 235 to prevent electrical signals from creating noise therebetween. The operation components may be, for example, an operator station 231 including operation equipment (e.g., input/output (I/O) devices 231a, power supplies 231b, monitors 231c, processors 231d, memory/databases 231e, etc.) for use with the tool processing system 101a, the tool assembly 120, and/or other portions of the wellsite 100 as is described further herein.

The assembly room 233a may operatively support the assembly equipment 230b therein. The assembly room 233a may have doors to allow connection to the feeder 228 of the storage 121 and/or the tool stager 122. Storage and other equipment may also be provided in the assembly room 233a as needed for use with the assembly equipment. The assembly equipment 230b may include various assembly equipment and/or tools for connecting tool components together to form the downhole tools 112a-c. The assembly equipment 230b may include, for example, a workstation with hand tools operated by an operator (not shown) to connect the tool components 225 together.

FIGS. 4B and 4C show an example version of the assembly equipment 230b in the form of a gun builder for threadedly connecting tool components, such as gun subs, together to form the perforating tool 112a. FIG. 4B shows the assembly equipment 230b positioned in the operations room 233b. FIG. 4C shows the assembly equipment 230b in greater detail. The assembly equipment 230b (gun builder) may include a build assembly 232a and a build conveyor 232b for putting the tool components 225 together to form the perforating tool 112a. The build conveyor 232b may selectively advance the tool components 225 into the build assembly 232a where the adjacent tool components 225 are selectively rotated and threadedly joined together. In this example, the build assembly 232a includes an axial chuck 223a for gripping a first downhole component 225 and a rotational chuck 223b for rotating a second downhole component 225 adjacent to the first downhole component 225 such that the first and second downhole components 225 are threaded together. The downhole components 225 and the downhole tool 112a are advanced through the chucks 223a,b by the build conveyor 232b.

As shown in FIGS. 4B and 4D, the assembly equipment 230b may also include devices for integrating the tool assembler 120 and/or the assembly equipment 230b with other portions of the tool processing system 101a. For example, a loader 237 may be connected to or integral with the tool feeder 228 for receiving the tool components 225 from the storage 121, and for passing the tool components 225 to the assembly equipment 230b for assembly. In the example shown, the loader 237 is a gantry loader including a platform 237a for storing tool components, a gantry frame 237b for supporting the tool components 225, a gantry gripper 237c for gripping the tool components 225, and a gantry driver 237d for moving the tool components 225 along the gantry frame and to the conveyor 232b for positioning onto the assembly equipment 230b for assembly.

As shown in FIGS. 4C and 4D, the assembly equipment 230b and/or the loader 237 may be provided with electronics for operation. These electronics may be used for monitoring, controlling, operating, etc. For example, the electronics may provide for automated, semi-automated, operation by operators, etc. Such electronics may include, for example, sensors S for detecting the tool components 225, gauges G sensing operating parameters of the assembly equipment, camera C for detecting location/identification, processor P processing data from the assembly equipment 230b, switch K for controlling operation of the assembly equipment 230b, and/or other equipment. Further details of the gun builder are described in U.S. Patent Application No. 63/135,910 and PCT Patent Application No. PCT/US22/11739, previously incorporated by reference herein.

Referring back to FIG. 2, in another example, a staging conveyor 239 may be connected to or integral with the build conveyor 232b for receiving the assembled downhole tool 112a therefrom. The staging conveyor 239 may also be connected to the stager 122 for passing the downhole tool 112a assembled by the tool assembler 120 to the tool stager 122. The staging conveyor 239 may include drives (not shown) for moving (e.g., receiving, pulling, drawing, and/or positioning) the perforating tool 112a from the staging conveyor 239 and to the tool stager 122.

As shown in FIGS. 2, and 3A—3B, the tool stager 122 may include the conveyor 239 for receiving and/or transferring the downhole tool 112a to the lift 124. The conveyor 239 as shown may be a conventional roller conveyor for moving the downhole tool 112a between the tool assembler 120 and the tool lift 124. Optionally, the tool stager 122 may also be provided with features to facilitate storage, sorting, inventorying, and/or otherwise manipulating the downhole tool(s) received from the assembly equipment 230b. For example, the tool stager 122 may be provided with a storage container 234a for holding one or more of the downhole tools 112a, and a sorter 234b selecting the downhole tools 112a for movement to the storage container 234a and/or the tool lift 124. Other devices for monitoring/scanning, detecting, etc. may also be provided.

The storage container 234a may be any container capable of receiving and storing the downhole tools 112a-c and/or other wellsite equipment 106. When needed, the stored downhole tools 112a-c may be passed by the sorter 234b from the storage container 234a to the storage container 234a and/or to the tool lift 124. The sorter 234b may be, for example, one or more conveyors capable of passing the downhole tools 112a-c from the tool assembler 120 to the storage container 234a, from the storage container 234a to the tool lift 124, and/or from the tool stager 122 directly to the tool lift 124 or other location. In at least some cases, the downhole tools 112a-c may be stored on the sorter 234b with or without passing to the storage container 234a. The sorter 234b may be coupled to the staging conveyor 239 at one end for receiving the assembled downhole tools 112a-c and to the tool lift 124 at another end for passing the selected downhole tools 112a-c to the tool lift 124. The sorter 234b may include additional portions for selectively diverting the downhole tools 112a-c about the storage container 234a, the tool lift 124, and/or other locations as desired. The tool stager 122 may also have capabilities for scanning, monitoring, and storing the downhole tools 112a-c and/or for performing staging operations, such as storage and sorting, as is described further herein.

As shown in FIGS. 2, 3A-3B, and 5A—5B, the tool lift 124 may include a lift base 236a and a lifter 236b. The lift base 236a may be a structure supported on the ground for housing and/or supporting the lifter 236b. The lifter 236b includes a lift arm 238a and a lift driver 238b. The lift arm 238a may be an elongate member movably (e.g., slidably and pivotally) connected to the lift base 236a and extendable therefrom. The lift arm 238a may be connectable to the tool stager 122 for receiving the downhole tools 112a therefrom. The lifter 236b may be connected directly to the tool stager 122 and/or the sorter 234b, or connected indirectly by a lift conveyor 236c to the tool stager 122 and/or the sorter 234b. The lift conveyor 236c may be connected at one end to the sorter 234b and at another end to the lift arm 238a for passing the downhole tools 112a-c from the tool stager 122 to the lift arm 238a. The lifter 236b may optionally have rollers, a conveyor, and/or other devices (not shown) thereon for facilitating receipt of the downhole tool 112a-c thereon.

The lift arm 238a may be movably positioned about the lift base 236a by the lift driver 238b. The lift driver 238b may be, for example, a motor positioned in the lift base 236a for selectively positioning (e.g., raising, sliding, tilting, orienting, etc.) the lift arm 238a about the lift base 236a and/or for operating the lifter 236b. The lift arm 238a is capable of receiving and supporting the downhole tool 112a during this positioning. For, example, the lifter 236b may have an end pivotally connected to the lift base 236a and another end raised at an angle α to a distance above the lift base 236b. The angle α and distance may be selected to position the downhole tool 112a for receipt and transport by to the tool transporter 126 (e.g., an angle α of from about 30 degrees to about 60 degrees). The tool lifter 124 may also have capabilities for monitoring and positioning the downhole tools 112a-c and/or for performing the lift operations as is described further herein.

As shown in FIGS. 2, and 3A—3B, the tool transporter 126 may be any device capable of automatic, semi-automatic, or manual operation to transfer the downhole tools 112a-c from the tool lift 124 to an assigned well 108a-c, such as a crane, conveyor, truck, or other mechanism. The tool transporter 126 may also be capable of moving any wellsite equipment 106 about any locations at the wellsite 100, such as from the tool assembly 120 directly to the wells 108a-c. The tool transporter 126 may be positioned at any location within reach of the equipment to be transported.

In the example shown in FIGS. 3A and 3B, the tool transporter 126 is a crane positioned about the tool lift 124 for receiving the downhole tools 112a-c from the lift arm 238a. The tool transporter 126 may include, for example, a vehicle 239a for moving the tool transporter 126 into position to the select location, a boom 239b carried by the vehicle 239a, a hoist 239c for lifting/lowering the downhole tool 112a about the boom 239b, and a gripper 239d for securing the downhole tool 112b to the hoist 239c. The tool transporter 126 may use the gripper 239d to secure the downhole tool 112a-c, the hoist 239c to raise and lower the downhole tool 112a-c, a lubricator 241 to receive the downhole tool 112a-c, and the boom 239b and/or the vehicle 239a to move the downhole tool into position for connection at the well 108a. Examples of tool transporters that can be used are described in PCT Application No. PCT/US22/11740, previously incorporated by reference herein.

The transporter 126 may also be used to facilitate use of the downhole tools 112a-c at the wells 108a-c. For example, the transporter 126 may carry the downhole tools 112a-c from the tool lift 124 and to the wells 108a-c in a structure, such as the lubricator (protective tubing) 241. For example, the downhole tool 112a may be inserted into the lubricator 241 and the transporter 126 may transport the lubricator 241 with the downhole tool 112a therein to the well 108. At the well 108a, the transporter 126 may positions the downhole tool 112a above the surface equipment 111a-d for connection of the lubricator 241 to the surface equipment 111. The downhole tool 112a may be attached to the conveyance 109a and lowered with the conveyance carrier (e.g., winch) 111a through the lubricator 241 and into the well 108a. The lubricator 241 may be detached from the surface equipment 111a-d and carried away by the transporter 126.

The tool transporter 126 may also be provided with devices for monitoring a position of the tool transporter 126 and/or downhole tools 112a-c. As also schematically shown in FIG. 3A, the tool transporter 126 may be provided with a wellsite sensor, such as a wellsite tracker (locator) T. This tracker T may be secured to the tool transporter 126 to monitor location and other operational parameters. The wellsite tracker T may have global positioning satellite (GPS) location capabilities for detecting a location of the transporter over time. In an example, the wellsite tracker T may include a GPS antenna 345a coupled to satellites for receiving GPS data, a location unit 345b (including memory, clock, gauge, and processor) for processing the GPS data, a power supply 345c, a communication unit 345d for communicating the GPS data to other monitoring devices, and a communication antenna 345e for sending/receiving the communication data. Examples of wellsite trackers that can be used are described in PCT Application No. PCT/US22/11740, previously incorporated by reference herein.

FIG. 2 also shows the conveyance carriers 111a in use with the wells 108a,b, respectively. One or more conveyance carriers 111a may be stationary or movably positioned about the wellsite 100. Each of the conveyance carriers 111a may be provided with a rotary spool for supporting the conveyance 109a. In an example, the conveyance (e.g., wireline) 109a may deployed from the conveyance carriers 111a and connected to the downhole tool 112a for movably supporting the downhole tool 112a in the well 108a and/or for providing a surface connection with the conveyance carriers 111a and/or other wellsite equipment 106. The conveyance carrier 111a may be coupled to the wireline truck 111d and/or the surface unit 117a for operation therewith. In another example, the conveyance (e.g., tubing) 109b may be deployed from a spool and connected to the injection equipment 110b for use therewith. The conveyance 109b may be communicatively coupled between the downhole tool 112a and the wellsite equipment 106, such as the surface unit 117a, the injection equipment 110b, the fracking equipment 111c, the wireline truck 111d, etc. The conveyance carriers 111a and/or the wellsite equipment 106 may also have capabilities, and/or be coupled to devices for monitoring and positioning the wellsite equipment 106 and/or for performing the wellsite operations as is described further herein.

As shown in FIGS. 3A-3B, the tool processing system 101a may include various configurations of one or more of the processing components. In the example shown in these figures, the tool processing system includes the component storage 121, the tool assembler 120, and the tool transfer 123. The tool stager 122 is integrated with the tool assembler 120 to receive the downhole tools therefrom, and the tool stager 122 is not integrated with the tool lift 124. The tool transporter 126 or other means may be used to move the downhole tools 112a-c between the various components. As demonstrated by this example, one or more portions of the tool processing system 101a may be separate, integrated, or eliminated. While not shown, a component storage 121 and connections between each of the processing components may optionally be provided.

While FIGS. 1A-5B show example configurations of the wellsite 100, the wellsite equipment 106, the well equipment 107a-c, the tool processing system 101a, and/or other devices positioned about wells 108a-c of a specific wellsite 100, such configurations may vary. For example, each well 108a-c may use one or more types of the well equipment 107a-c over time for performing various well operations, and one or more portions of the wellsite equipment 106 may be provided to support one or more wellsite operations. The various equipment described herein may be automatic, semi-automatic, and/or manually operated. The various equipment described herein may also be provided with monitoring and/or control capabilities as described further herein. In some versions, part or all of the tool processing system 101a may be formed into an integrated system positionable at the wellsite 100, or positioned offsite. One or more of the features described herein may be combined in various arrangements, with zero or more features excluded.

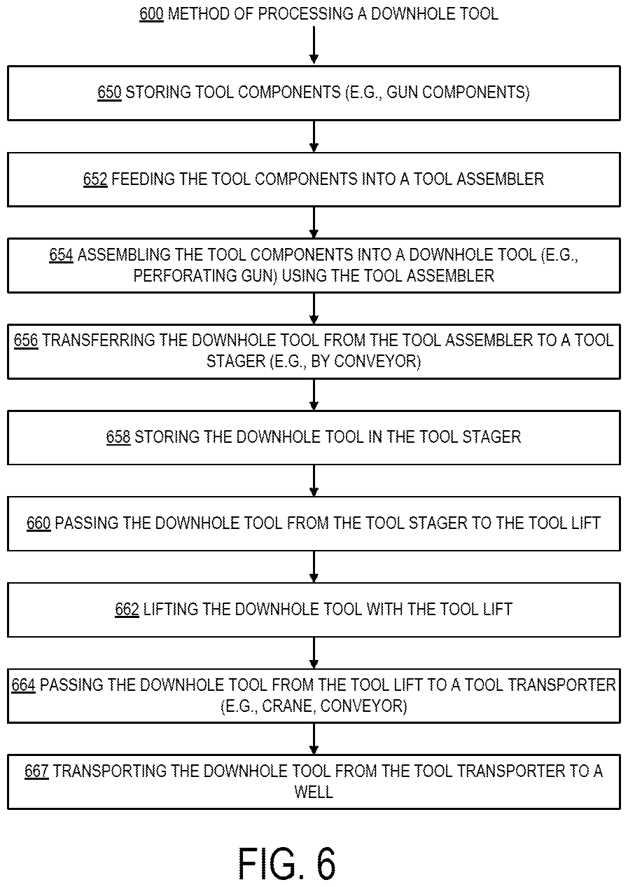

FIG. 6 is a flow chart depicting a method 600 of processing a downhole tool. The method involves (650) storing tool components, (652) feeding the tool components into a tool assembler, (654) assembling the tool components into a downhole tool using the tool assembler, (656) transferring the downhole tool from the tool assembler to a tool stager, (658) storing the downhole tool in the tool stager, (660) passing the downhole tool from the tool stager to the tool lift, (662) lifting the downhole tool with the tool lift, (664) passing the downhole tool from the tool lift to a tool transporter, and (667) transporting the downhole tool from the tool transporter to a well.

Part or all of the method 600a may be performed at any time. Portions of the method 600 may be optional. Part or all of the method 600 may be repeated. Part or all of the method 600 may be performed using separate, integrated, manual, semi-automatic, and/or automatic techniques.

### Well Site Monitoring

The present disclosure also relates to a wellsite monitoring system usable with the tool processing system. The wellsite monitoring system includes wellsite sensors (and/or trackers), wellsite monitors, and a central station coupled (by wire or wirelessly) about the wellsite for providing communication, information capture, and cooperation between one or more portions of the wellsite. The wellsite sensors may be positioned about the wellsite to capture and process various wellsite data, such as tool, equipment, well, processing, and other data. The wellsite sensor(s) may include, for example, a wellsite tracker located about wellsite equipment. The wellsite tracker may include a location unit (e.g., a global positioning sensor (GPS) and processor), a communication unit (e.g., a transceiver), a location memory (e.g., database), and a power source (e.g., a battery) housed in a tracker housing. The wellsite tracker may be used to track a spatial location of the transporter (and/or the well equipment carried by the transporter) versus time as the transporter moves about a well. The wellsite sensor(s) may also include, for example, a process sensor (e.g., an assembly sensors) coupled to portions of the tool processing system (e.g., the tool assembler) for detecting and measuring processing operations (e.g., location, position, identification, assembly, torque, etc.).

The wellsite monitor may be coupled (by wire or wirelessly) to the wellsite sensors to capture and process tracker (and/or other) data captured by the wellsite sensors. The wellsite monitor may be used, for example, to collect data from the wellsite tracker and to monitor the location versus time of the transporter (and/or the well equipment carried by the transporter). The wellsite monitor may also be coupled to various sensors and/or monitors located about the wellsite, and/or at offsite locations. The wellsite monitor may also be used to collect data from the process sensors to detect processing, and make adjustments as needed.

The central station may capture and process (e.g., collect, communicate, analyze, generate, and/or otherwise act upon) the data received from one or more of the sensors and/or one or more of the monitors. The central station may be a centralized facility housed with portions of the tool processing system for receiving and integrating the data from the wellsite sensors and the wellsite monitors. This integrated data may be used to combine information from multiple sources about the wellsite for use in operating the tool processing system and other portions of the wellsite from a central location.

The wellsite monitor and/or the central station may combine and/or analyze sensor data and/or analyzed outputs gathered from the wellsite sensors and other well devices (e.g., downhole, surface, offsite, and/or other sensors, databases, and/or monitors). The wellsite monitor and/or the central station may then generate outputs (e.g., displays, reports, alarms, etc.) based on the collected and/or processed data. The wellsite monitor and/or the central station may also be used for confirming operating conditions about the wellsite (e.g., the proper equipment is at the proper well, operations are performed timely, specifications are met etc.), for generating outputs (e.g., displays, reports, alarms, etc.) based on the collected and/or processed data, and/or for operating the tool processing system and/or other portions of the wellsite.

The wellsite monitoring system and/or methods described herein are also intended to provide one or more of the following, among others: collecting data from various portions of the wellsite, collecting processed information from various portions of the wellsite, combining the data and the information from various portions of the wellsite, generating integrated analysis based on data and processed information from multiple sources, confirming wellsite operations meet specification, providing alarms for improper equipment and/or out of specification conditions, identifying equipment placement at various times, considering sensor and monitor data across multiple portions of the wellsite, determining location of well equipment versus time, confirming proper equipment is provided to a correct location, considering equipment location data with other wellsite data, detecting job delays, detecting job delays, providing security for locating well equipment, providing outputs (e.g., displays, reports, alarms, etc.) concerning location and other data, etc.

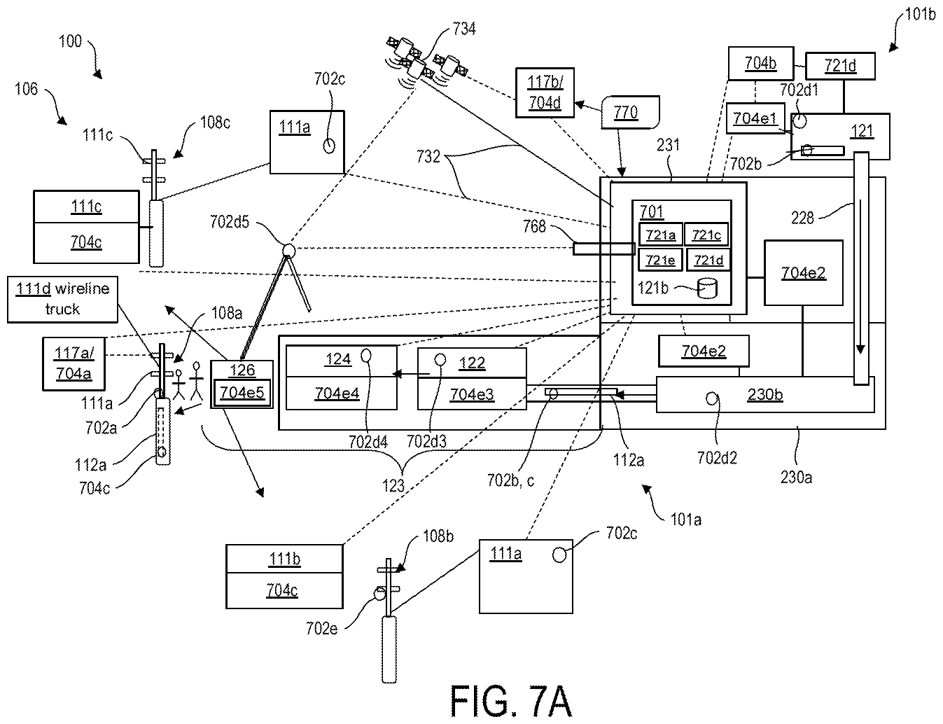

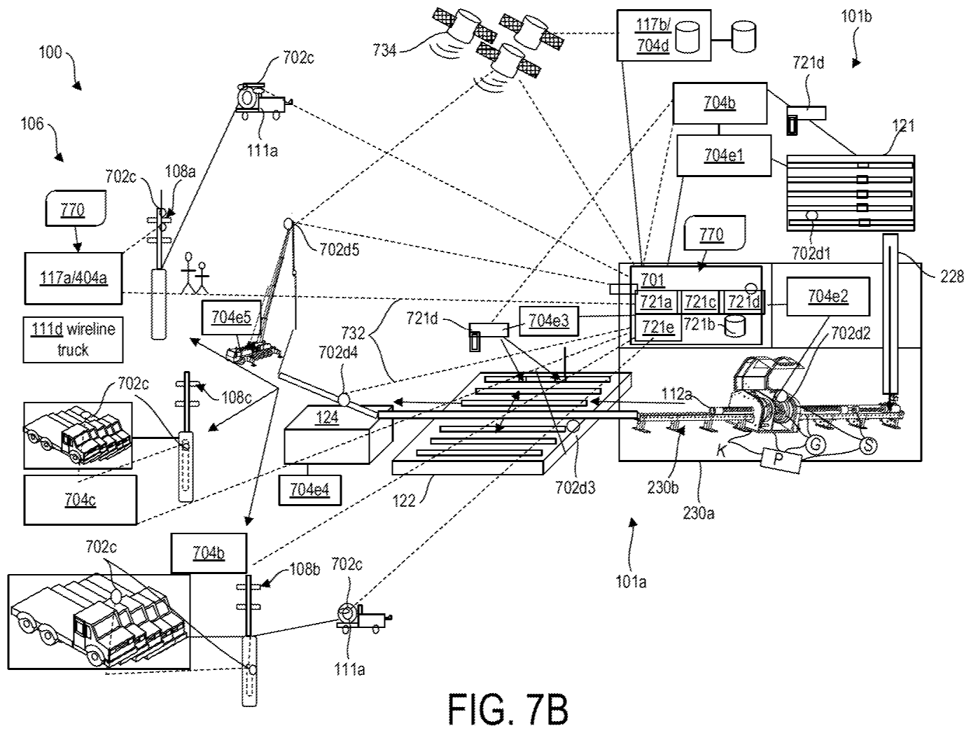

FIG. 7A-7B are schematic diagrams depicting the tool processing system 101a and a wellsite monitoring system 101b positioned about the wellsite 100. These figures show another view of the tool processing system 101a and the wellsite 100 as described in FIGS. 1A and 1B. These figures also show details of the well monitoring system 101b in use with the tool processing system 101a and the other wellsite equipment 106 at the wellsite 100. While this example depicts use of the wellsite monitoring system 101b with specific equipment and configurations, other configurations of the wellsite 100 and/or the wellsite monitoring system 101b may be used. Examples of techniques for monitoring that may be used are provided in PCT Application No. PCT/US22/11740, previously incorporated by reference herein.

The wellsite monitoring system 101b includes a central station 701, sensors 702a-d5, and wellsite monitors 704a-e5. The central station 701 is positioned in the assembly facility 230a, but may be at other locations about the wellsite 100. The sensors 702a-d5 and the monitors 704a-e5 are positioned about the wellsite equipment 106 for sensing and processing data from their respective locations about the wellsite. The central station 701 may communicate with the sensors 702a-d5 and the monitors 704a-e5 to process on one or more portions of the data collected from each of the locations about the wellsite.

The sensors 702a-d5, the wellsite monitors 704a-e5, and the central station 701 may be communicatively coupled by communication links 732 as schematically indicated by the dotted lines. The communication links 732 may be wired or wireless links used to create a communication network with various onsite or offsite locations. The communication links 732 may extend between any of the devices shown, and may be conveyed directly or via another device. For example, the communication link from the central station 701 may be conveyed by satellites 734 or another monitor 704a-e5 to one or more of the other monitors 704a-e5.

One or more of the sensors 702a-d5 may be positioned about the wellsite 100 for collecting and communicating data concerning the wells 108a-c, the downhole tools 112a-c, the surface equipment 111, etc. Each of the sensors 702a-d5 may include a gauge for measuring data, a memory for storing the data, and/or a processor for processing the data. The sensors 702a-d5 may include, for example, a well sensor 702a, a tool sensor 702b, an equipment sensor 702c, and processing sensors 702d1-5.

Each of the sensors 702a-d5 may be positioned about the wellsite 100 to gather information concerning one or more wellsite parameters. The well sensor 702a may be a sensor positioned at the wells 108a-c for measuring well parameters concerning operation of the wells 108a-c. For example, the well sensor 702a may be coupled to the surface equipment 111a-d to measure well operating parameters, such as pressures of fluids, detected pumping conditions, detected equipment position, etc. The well sensor 702a may also collect well status parameters concerning the well(s) 108a-c, such as well location, well identification, equipment type, wellbore conditions, etc. The well sensor 702b may also be used to detect well equipment at the well 108a-c, such as the well lubricator 241, the wireline tool 112a, and the surface equipment 111a-d, as well as activity involving the wells 108a-c.

The tool sensor (and/or identifier) 702b may be positioned, on or about, the tool components 225 and/or the downhole tools 112a-c. The tool sensor 702b may be attached to one or more of the tool components 225 that are assembled to form the downhole tools 112a-c, thereby also acting as the tool sensor 702b for the downhole tools 112a-c as the tool components 225 and/or the downhole tools 112a-c move about the tool processing system 101a and/or the wellsite 100. The tool sensor 702b may be any device capable of sensing and/or storing information about the tool components 225, the downhole tools 112a-c, and/or its surroundings. For example, the tool sensors 702b may be provided with gauges capable of measuring environmental conditions, such as temperature, humidity, etc. In another example, the tool sensor 702b may be provided with an identifier, such as a bar code, RFID, serial number, etc., capable of providing equipment information about the tool components 225 and/or the downhole tools 112a-c (e.g., tool identification, tool type, etc.). The tool sensor 702b may optionally be updated at various locations about the wellsite 100, such as after tool assembly at the assembly equipment 230b.

The equipment sensor 702c may be positioned at various locations about the downhole tool 112a-c and wellsite equipment 106 used therewith, such as the winches 111a, the injection truck(s) 110b, the fracking trucks 110c, and/or the wireline truck 110d. The equipment sensor 702c may include internal and/or external sensors coupled to the downhole tools 112a-c, the winches 111a, the injection truck(s) 110b, the fracking trucks 110c, and/or the wireline truck 110d for collecting data concerning operation of the downhole tools 112a-c and the wellsite equipment 106. For example, the equipment sensor 702c may be capable of collecting wireline parameters, such as downhole conditions (e.g., operation logs, time data, perforation data (e.g., time, number, and placement of charges), etc.), winch parameters (e.g., such as weight, length, torque, tension, time, etc.), injection parameters (e.g., such as downhole conditions, pumping pressures, fluid parameters, operation logs, time data, etc.), fracking parameters (e.g., such as downhole conditions, pumping materials, fluid parameters, operation logs, time data, etc.), etc.

The processing sensors 702d1-d5 may include one or more internal and/or external gauges or other data capture devices positioned about the tool processing system 101a. The sensors 702d1-d5 may include, for example, a storage sensor 702d1, an assembly sensor 702d2, a staging sensor 702d3, a lift sensor 702d4, and a transport sensor 702d5 for collecting data concerning operation of the processing operations.

The storage sensor 702d1 may be positioned about the component storage 121 for collecting storage parameters (e.g., storage location, capacity, storage equipment, storage scheduling, and storage conditions (e.g., humidity, temperature, etc.)), component parameters (e.g., inventory, scheduling, etc. of the tool components 225), and feeder parameters (e.g., feed rate, component position, etc. of the tool feeder 228).

The assembly sensor(s) 702d2 may be positioned about the assembly equipment 230b and/or the loader 237 for collecting assembly parameters, such as component intake parameters (e.g., feed rate, positioning, capacity, intake rate, etc.), connection parameters (e.g., torques, drive rates, position, threading, etc.), and outtake parameters (e.g., outtake rate, positioning, capacity, etc.). As shown in FIGS. 4C and 4D, the assembly sensor 702d2 may include a sensor S, a gauge G, a camera C, or other devices capable of collecting data about the assembly equipment 230b and/or the loader 237.

Referring back to FIG. 7A, the staging sensor 702d3 may be positioned about the tool stager 122 for collecting staging parameters, such as component storage parameters (e.g., storage location, capacity, storage equipment, storage scheduling, etc.), storage conditions (e.g., humidity, temperature, etc.), scheduling parameters (e.g., sequencing, order, delivery, etc.), and conveyor parameters (e.g., intake rate, transfer rate, outtake rate, tool positioning/location, capacity, etc.).

The lift sensor 702d4 may be positioned about the tool lift 124 for collecting lift parameters, such as motion parameters (e.g., lift angle, torques, drive rates, position, etc.) and motion parameters (e.g., outtake rate, positioning, capacity, etc.), and conveyor parameters (e.g., intake rate, transfer rate, outtake rate, tool positioning/location, capacity, etc.).

The transport sensor(s) 702d5 may be positioned about the tool transporter 126 for collecting transport parameters, such as attachment parameters (e.g., position, locking, equipment ID, etc.), transfer parameters (e.g., intake rate, outtake rate, speed, etc.), and location parameters (e.g., spatial location, time/date, delivery address, etc.). This wellsite tracker 702a may be positioned at various locations about the transporter 126 and/or the well equipment 106 carried by the transporter 126. For example, the wellsite tracker 702a may be located about the vehicle 124a, the boom 124b, the hoist 124c, the lubricator 241, the wireline tool 112a carried by the transporter 126, etc. As shown in FIG. 3A, the transport sensor 702d5 may be, for example, a well tracker T with GPS location and other capabilities.

The wellsite tracker 702a may also be positioned about the wellsite 100 to track movement of equipment, personnel, etc. The wellsite tracker 702a may be provided with capabilities for collecting and storing transporter parameters (e.g., spatial location, time, etc.) concerning the transporter 126, the well equipment 106 carried by the transporter, the wells 108a-c, or other aspects of the wellsite 100. An example well tracker that may be used is described in PCT Application No. PCT/US22/11740, previously incorporated by reference herein.

One or more wellsite monitors 704a-e5 may be positioned about the wellsite 100 for processing the data collected by the sensors 702a-d5. The wellsite monitors 704a-e5 may include, for example, a well monitor 704a, a tool monitor 704b, an equipment monitor 704c, an offsite monitor 704d, and processing monitors 704e1-e5.

Each of the monitors 704a-e5 may include various processor components 721a-d, such as communicators (e.g., transceivers, antennas, etc.) 721a capable of sending/receiving signals, a database (e.g., memory) 721b capable of storing data, controllers (e.g., central processing units (CPUs), processors, etc.) 721c capable of processing the data, input/output (I/O) devices 721d (e.g., scanners, keyboards, touchscreens, monitors, printers, displays, etc.) capable of inputting data and generating outputs (e.g., displays, reports, alarms, etc.), computer readable medium 721e (e.g., software) capable of processing data and/or operating equipment, and other processor components. For simplicity, the processor components 721a-d are only shown in FIGS. 7A-7B as being positioned in the central station 701, but may also be included in one or more of the monitors 704a-e5.

The well monitor 704a may be coupled (wirelessly or by wire) to the well sensor(s) 702a for collecting data from the well sensor(s) 702a. The well monitor 704a may be used for collecting and processing the data received from these well sensors 702a. For example, the well monitor 704a may generate well parameters about the wells 108a-c, such well identification, equipment identification, crew identification, well location, operating parameters, etc. The equipment monitor 704b may also generate outputs, such as job logs, equipment schedules, crew assignments, maintenance needs, etc. The well monitor 704a may be part of, or coupled to, the surface unit 117a. The well monitor 704a may be a separate unit that works as a stand-alone system, or as an integral part of the surface unit 117a.

The tool monitor 704b may be coupled (wirelessly or by wire) to the tool sensor(s) 702b for collecting data from the tool sensor(s) 702b. The tool monitor 704b may be used for processing the data received from the tool sensors 702b. For example, the tool monitor 704b may generate tool parameters about the tool components 225, such identification, specifications, assigned location, operating parameters, etc. The tool monitor 704b may also generate outputs, such as tool inventories, equipment schedules, maintenance needs, etc.

The tool monitor 704b may include or be coupled to an input/output device 721d, such as a scanner (e.g., stationary or mobile scanner, scanning gun, etc.). The scanner 721d may be used, for example, for scanning the tool sensor 702d1 information about the tool components 225 into the equipment monitor 704b. Information may also be manually entered into the tool monitor 704b. Based on the collected tool data, the equipment monitor 704b may generate outputs, such as equipment schedules, equipment logs, client specs, etc.

The equipment monitors 704c may be positioned about various wellsite equipment 106, such as the winches 111a, the downhole tools 112a-c, the injection equipment 111b, the fracking equipment 111c, and/or the wireline truck 11d. The equipment monitors 704c may be coupled to the equipment sensors 702c for collecting and processing data received from the equipment sensors 702c. For example, the equipment monitor 704c may be coupled wirelessly and/or by the conveyance 109c to the equipment sensor 702c positioned in the downhole wireline tool 112a. The equipment monitors 704c may generate various parameters from the equipment sensors 702c, such as winch parameters about the winch 111a (e.g., tension, length, time, etc.), wireline parameters about the wireline tool 112a (e.g., serial numbers, model numbers, downhole measurements, wellbore conditions, job time, etc.), injection parameters about the injection equipment 110b (e.g., pumping pressure, fluid pressure, etc.), fracking parameters about the fracking equipment 110c (e.g., the fluid flow rate, pressures, etc.), and wireline parameters about the wireline truck 110d (e.g., perforations, depth, location, etc.). The equipment monitors 704c may also generate outputs, such as job logs, perforation timing, number and location of perforations, etc.

The offsite monitor 704d may be positioned at the offsite unit 117b. The offsite monitor 704d may be coupled to one or more of the sensors 702a-d5 and/or the other monitors 704a-e5 to collect data therefrom. The offsite monitor 704d may also be coupled to other sources, such as a library 770, to receive data therefrom. The offsite monitor 704d may collect generate wellsite parameters about the wellsite 100, customers (e.g., client data), the company operating the wellsite 100, historical data, etc. The offsite monitor 704d may also generate outputs, such as schedules, reports, comparisons, alarms, etc.

The processing monitors 704e1-e5 include a storage monitor 704e1, an assembly monitor 704e2, a staging monitor 704e3, a lift monitor 704e4, and a transport monitor 704e5 positioned about the component storage 121, the assembly facility 230a, the assembly equipment 230b, the tool stager 122, the tool lift 124, the tool transporter 126, respectively. The various monitors 704e1-e5 may be positioned with, or a distance from, their respective wellsite equipment 106. The processing monitors 704e1-e5 may be used for collecting and processing data received from the sensors 702a-d5. The monitors 704e1 may also be coupled to the input/output device (scanner) 721d for receiving scanned tool data therefrom. The monitors 704e1-e5 may also generate outputs, such as equipment schedules, equipment logs, client specs, etc.

The central station 701 may be positioned at various locations about the tool processing system 101a and/or the wellsite 100 for collecting data from one or more of the sensors 702a-d5 and/or from one or more of the other monitors 704a-e5. As shown in FIGS. 7A and 7B, the central station 701 may be positioned in the assembly facility 230a (mobile trailer) at the wellsite with the tool assembly 120. While the central station 701 is shown positioned about the assembly facility 230a, the central station 701 may be positioned in any location about the wellsite.

The central station 701 may be coupled (wirelessly or by wire) by one or more of the communication links 732 to the sensors 702a-d5 and the well monitors 704a-e5. In this position, the central station 701 is able to send and receive raw and/or processed data from these multiple sources. The central station 701 is also able to generate complex outputs based on these multiple sources, such as schedules, reports, comparisons, alarms, etc., and to monitor, control. The central station 701 is also able to operate the assembly equipment 230b and/or other wellsite equipment 106 from the operator station 231 within the assembly facility 230a.

The central station 701 may act as a monitor for other of the well sensors 702a-d5 and/or the well monitors 704a-e5. For example, the well monitor 704a may be coupled to the transporter sensors 702d5 and/or the transporter monitor 704e5. The transporter sensors 702d5 may be wellsite trackers with GPS location tracking capabilities for sending data via antenna 768 to the central station 701. These wellsite tracker(s) 702d5 may send signals directly to the central station 701 (and/or the transporter monitor 704e5) at intervals (e.g., ping every 30 seconds) to identify any changes in location. The central station 701 may then determine location information concerning the equipment carried by the transporter 126, and confirm the transporter operation. Techniques for tracking are described in PCT Application No. PCT/US22/11740, previously incorporated by reference herein.

The various monitors 704a-e5 may be integrated with, or coupled to, other monitors 704a-e5 about the wellsite 100. The various monitors 704a-e5 may be integrated with, or coupled to, the surface unit 117a, the offsite unit 117b, the libraries 770, etc. The monitors 704a-e5 may also be coupled to the sensors 702a-f, the input/output device (scanner) 721d, and/or other devices for operation therewith. Examples of monitors and monitoring techniques that may be used is described in PCT Application No. PCT/US22/11740, previously incorporated by reference herein.

While FIGS. 7A-7B show an example layout for the wellsite 100 and the wellsite monitoring system 101b, variations are within the scope of this disclosure. The monitoring system 101b may be positioned about any wellsites 100 with a variety of wells 108a-c and/or wellsite equipment 106. The wellsite monitoring system 101b may include one or more of the sensors 702a-d5, monitors 704a-e5, communication links 732, and/or one or more surface/offsite units 117a,b, as well as other sensors 702a-d5, monitors 704a-e5, etc., at various locations. One or more of the monitors 704a-e5 may also be combined or coupled together for communication therebetween. One or more of the sensors 702a-d5 may also be provided with an internal monitor (not shown) and/or capabilities for monitoring. The communication link 732 may extend directly from the sensors 702a-d5 to the central station 701, and/or from the sensors 702a-d5 to the one or more of the other monitors 704a-d5.

In an example, the sensors 702a-e5 may be used to collect processing data concerning the tool processing system 101a. The processing data may include, for example, tracking data collected from a well tracker T concerning position of certain of the tool processing system 101a, such as the transporter 126. The tracking data may include, for example, position over time of the transporter 126 to confirm the location of the transporter 126. This information may be collected and analyzed by the monitors 704a-e5 and/or the central station 701 to generate tracking and/or processing analysis. The tracking data may be combined with other data collected and/or analyzed by the monitors 704a-e5, and further processed by the central station 701. In this manner, the monitoring system 101b may be used to monitor the location of equipment, such as portions of the processing system 101a and/or the tools 112a-c processed thereby. This information may be used, for example, to facilitate movement of the downhole tools 112a-c about the processing system 101a and/or the wellsite 100. The processing system 101a may be operated by the central station 701 based on the analysis. The downhole tools 112a-c and the equipment may be operated and processed at the central station 701 based on the collected processing and/or wellsite data, analysis, and/or further analysis.

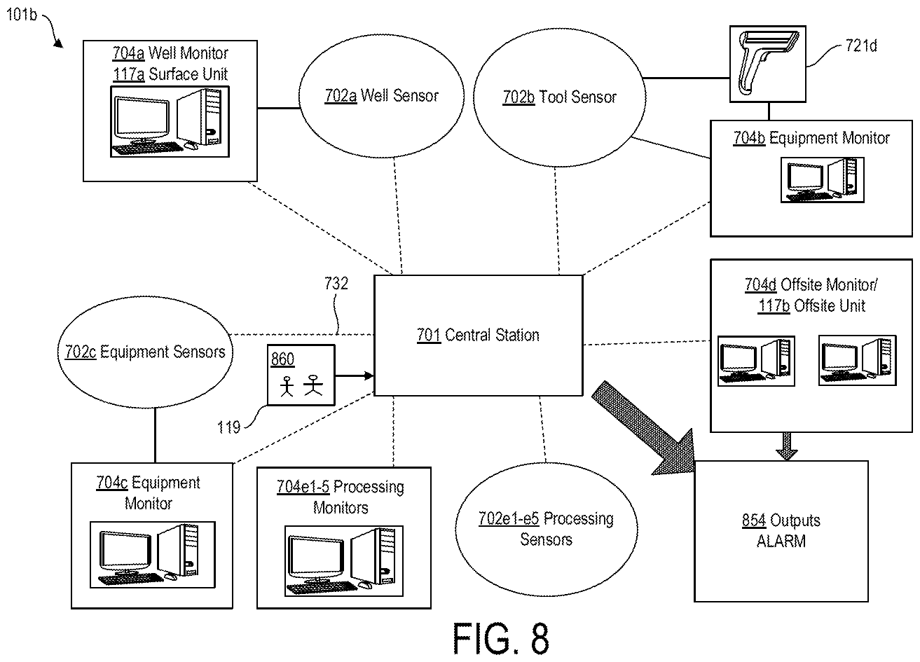

FIG. 8 is a schematic diagram of the wellsite monitoring system 101b for performing multiple wellsite operations. As shown in this view, the central station 701, the multiple sensors 702a-e5, and the multiple monitors 704a-e5 may be used to integrate captured data and analyze wellsite operations. As also shown in this view, the wellsite monitors 704a-e5 may be independent components, or combined with other equipment, such as the central station 701, the surface unit 117a and/or offsite unit 117b. While not shown, one or more of the monitors 704a-d5 may optionally be part of or coupled to another monitor, such as the equipment monitors 704c located in the wireline truck 110d (FIG. 1B).

In the example in FIG. 8, the central station 701, the various sensors 702a-d5 and the wellsite monitors 704a-e5 are interconnected by the communication links 732 to allow cross communication therebetween. The data from the various sensors 702a-d5 may be combined within one or more of the wellsite monitors 704a-e5 to generate various outputs 854. One or more of the wellsite monitors 704a-e5 may be used to manipulate the data collected by one or more of the various sensors 702a-d5 and/or one or more external sources, such as one or more onsite and/or offsite libraries 770 (FIG. 7A), as well as information that may be input 860 by the crews 119 at the central station 701, by scanner 721d, and/or at one or more of the monitors 704a-e5. The combination of sources provides the ability to combine location data from the sensors 702a-d5 with other data to provide outputs based on the data collected by the monitors 704a-e5. The various data may be combined and analyzed across multiple sources to provide the ability to analyze various combinations of information about operations.

For example, the wellsite monitoring system 101b may be used to generate outputs based on a combination of data from the wellsite trackers 702d5 and/or the other sensors 702a-d4. One or more of the well monitor(s) 704a-e5 may combine the location data with the various data to generate the location-based outputs concerning the processing of the downhole tools 112a-c. For example, the locations generated over time by the wellsite trackers 702a can be combined with wireline data and fracking data to assure proper placement of equipment and to determine delays in operations. This location detection may also identify missing, lost, and/or stolen equipment to assure security of equipment use and placement, as well as identifying unusual operational events and/or costly delays.

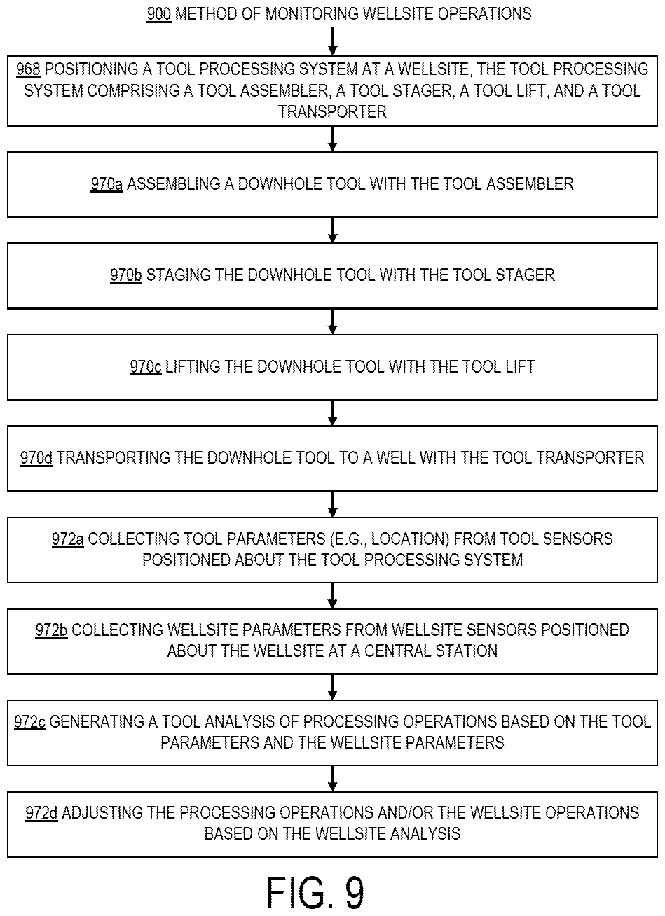

FIG. 9 is a flow chart depicting a method 900 of monitoring wellsite operations. The method 900 involves (968) positioning a tool processing system at a wellsite, the tool processing system comprising a tool assembler, a tool stager, a tool lift, and a tool transporter, (970a) assembling a downhole tool with the tool assembler, (970b) staging the downhole tool with the tool stager, (970c) lifting the downhole tool with the tool lift, and (970d) transporting the downhole tool to a well with the tool transporter. The method may also involve storing tool components. The method 900 further involves (972a) collecting tool parameters (e.g., location) from tool sensors positioned about a tool processing system, (972b) collecting wellsite parameters from wellsite sensors positioned about the wellsite at a central station, (972c) generating a tool analysis of processing operations based on the tool parameters and the wellsite parameters, and (972d) adjusting the processing operations and/or the wellsite operations based on the wellsite analysis.

Part or all of the method may be performed in any order, or as needed. Part or all of the methods herein may be performed using hardware (e.g., processors), software (e.g., computer readable medium (transitory or non-transitory)), and or the monitors described herein.

As used herein, “computer readable medium” or “machine-readable storage medium” may include a storage drive (e.g., a hard drive), flash memory, Random Access Memory (RAM), any type of storage disc (e.g., a Compact Disc Read Only Memory (CD-ROM), any other type of compact disc, a DVD, etc.) and the like, or a combination thereof. In some examples, a storage medium may correspond to memory including a volatile (main) memory, such as RAM, where software may reside during runtime, and a secondary memory. The secondary memory can, for example, include a non-volatile memory where a copy of software or other data is stored.

As provided above, examples in the present disclosure may also be directed to a non-transitory computer-readable medium storing computer-executable instructions and executable by one or more processors via which the computer-readable medium is accessed. A computer-readable media may be any available media that may be accessed by a computer. By way of example, such computer-readable media may include random access memory (RAM), read-only memory (ROM), electrically erasable programmable read-only memory (EEPROM), compact disk read-only memory (CD-ROM) or other optical disk storage, magnetic disk storage or other magnetic storage devices, or any other medium that may be used to carry or store desired program code in the form of instructions or data structures and that may be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Note also that the software implemented aspects of the subject matter claimed below are usually encoded on some form of program storage medium or implemented over some type of transmission medium. The program storage medium is a non-transitory medium and may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The claimed subject matter is not limited by these aspects of any given implementation.

Furthermore, examples disclosed herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. A processor(s) may perform the necessary tasks.

This description of preferred embodiments is to be read in connection with the accompanying drawings, which are part of the entire written description of this invention. In the description, corresponding reference numbers are used throughout to identify the same or functionally similar elements. Relative terms such as “horizontal,” “vertical,” “up,” “upper”, “down,” “lower”, “top”, “bottom”, “anterior” and “posterior” as well as derivatives thereof (e.g., “horizontally,” “downwardly,” “upwardly,” etc.) should be construed to refer to the orientation as then described or as shown in the drawing figure under discussion. These relative terms are for convenience of description and are not intended to require a particular orientation unless specifically stated as such. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship.

While the embodiments are described with reference to various implementations and exploitations, it will be understood that these embodiments are illustrative and that the scope of the inventive subject matter is not limited to them. Many variations, modifications, additions and improvements are possible. For example, various combinations of one or more of the features and/or methods provided herein may be used.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter. For example, while certain tools and components (e.g., assemblies) are provided herein, it will be appreciated that various configurations (e.g., shape, order, orientation, etc.) of such tools and/or components may be used. While the figures herein depict a specific configuration or orientation, these may vary. First and second are not intended to limit the number or order.

Insofar as the description above and the accompanying drawings disclose any additional subject matter that is not within the scope of the claim(s) herein, the inventions are not dedicated to the public and the right to file one or more applications to claim such additional invention is reserved. Although a very narrow claim may be presented herein, it should be recognized the scope of this invention is much broader than presented by the claim(s). Broader claims may be submitted in an application that claims the benefit of priority from this application.

What is claimed is:

1. An integrated tool processing system for processing a downhole tool at a wellsite, the integrated tool processing system comprising:
a tool assembler comprising assembly equipment positioned at the wellsite, the assembly equipment comprising a tool conveyor and a gun builder positioned along the tool conveyor, the gun builder comprising gun chucks to threadedly connect portions of the downhole tool together;
a tool lift operatively connected by a tool stager to the tool assembler, the tool stager comprising a staging conveyor connected between the tool conveyor and the tool lift to transfer the downhole tool therebetween, the tool lift comprising a lift base to receive the downhole tool and a lift arm, the lift arm movably positionable at an angle to the lift base whereby the downhole tool is lifted about the lift base; and
a tool transporter comprising vehicle positionable about the wellsite and a boom extending above the vehicle, the boom positionable about the lift arm and connectable to the downhole tool, the vehicle and the boom carrying the downhole tool into position for delivery at the wellsite.

2. The integrated tool processing system of claim 1, further comprising a tool storage operatively connected to the tool assembler, the tool storage comprising a storage container to store portions of the downhole tool and a feeder, the feeder coupled to the tool conveyor to deliver the portions of the downhole tool to the tool assembler.

3. The integrated tool processing system of claim 1, further comprising a loader operatively connected to the tool assembler, the loader comprising a platform, a frame, and a driver, the driver movably positionable about the frame, the drive having a gripper to releasably support the portions of the downhole tool.

4. The integrated tool processing system of claim 1, wherein the tool stager is operatively connected to the tool conveyor, the tool stager comprising a staging conveyor to receive the downhole tool from the tool assembler.

5. The integrated tool processing system of claim 4, wherein the tool stager further comprises a staging storage and a sorter.

6. The integrated tool processing system of claim 1, further comprising a monitoring system comprising wellsite sensors positioned about the wellsite to collect data, monitors positioned about the wellsite to process the data from the wellsite sensors, and a central processing unit centrally located about the wellsite to process data from multiple monitors.

7. The integrated tool processing system of claim 6, wherein the wellsite sensors comprise a wellsite tracker, the wellsite tracker comprising a global positioning satellite sensor.

8. The integrated tool processing system of claim 1, wherein the tool assembler comprises an assembly facility, the assembly facility comprising a housing with an operations room for electronic equipment and an assembly room for the assembly equipment, the operations room separated from the assembly room by a barrier.

9. A method of processing downhole tools for use at a wellsite, the method comprising:
assembling a downhole tool by:
passing portions of the downhole tool along an assembly conveyor and into a gun builder; and
threadedly connecting the portions of the downhole tool using the gun builder;
passing the downhole tool from the gun builder to a tool lift by passing the downhole tool from the assembly conveyor to the tool lift via a tool stager;
lifting the downhole tool at an angle using the tool lift; and
transporting the downhole tool from the tool lift about the wellsite.

10. A wellsite monitoring system for monitoring wellsite equipment at a wellsite, the wellsite monitoring system comprising:
wellsite sensors positioned about the integrated tool processing system of claim 1 to collect wellsite data;
wellsite monitors positioned about the wellsite, the wellsite monitor coupled to the wellsite sensors to receive wellsite data therefrom, the wellsite monitors comprising monitor processors to generate monitor outputs based on the wellsite data; and
a central station positioned at the wellsite, the central station coupled to the wellsite monitors to receive the wellsite data and the monitor outputs therefrom, the central station comprising a central processor to generate central outputs based on the monitor outputs and the wellsite data.

11. The wellsite monitoring system of claim 10, wherein the wellsite monitors further comprise a monitor communicator, a memory, an input/output device, and a computer readable medium.

12. The wellsite monitoring system of claim 10, wherein the wellsite sensors comprise a wellsite tracker.

13. The wellsite monitoring system of claim 10, wherein the wellsite sensors comprise a well sensor, an equipment sensor, a wireline sensor, an injection sensor, and combinations thereof.

14. The wellsite monitoring system of claim 10, wherein the wellsite monitors are coupled together by communication links.

15. A method of monitoring wellsite operations at a wellsite, the method comprising:
collecting tool parameters from tool sensors positioned about the integrated tool processing system of claim 1;
collecting wellsite parameters from wellsite sensors positioned about wellsite equipment at the wellsite;
generating a tool analysis of processing operations based on the tool parameters, the tool analysis comprising a location of the downhole tool over time;
generating a wellsite analysis based on the tool parameters and the wellsite parameters; and
performing processing operations based on the wellsite analysis.

16. The method of claim 15, wherein the tool sensors comprise a well tracker and wherein the collecting tool parameters comprises collecting location parameters from a wellsite tracker; and
adjusting the processing operations based on the tool analysis.

17. The method of claim 16, wherein the collecting comprises using the wellsite tracker, receiving location data from satellites as portions of the tool processing system move about the wellsite, and wherein the generating comprises inferring tracking data for the portions based on the location data over time, the tracking data comprising spatial location and the time of the portions and confirming the portions by comparing the tracking data for the portions with predetermined specifications.

18. The method of claim 15, further comprising adjusting the processing operations based on the tool analysis.

19. The method of claim 15, further comprising generating outputs from the tool analysis.

20. The method of claim 19, wherein the outputs comprise maps, charts, reports, analysis, alarms, feedback, control decisions, and combinations thereof.

21. The method of claim 19, wherein the generating comprises generating an alarm when the tool parameters are outside of a predetermined range of predetermined specifications.

22. The method of claim 15, further comprising confirming the wellsite operations by comparing the tool parameters with predetermined wellsite specifications.
